(19) United States
(12) Patent Application Publication
(10) Pub. No.: US 2025/0348444 A1
(43) Pub. Date: Nov. 13, 2025

(54) DATA MIGRATION METHOD AND APPARATUS, DEVICE, AND MEDIUM

(71) Applicant: IEIT SYSTEMS CO., LTD., Jinan, Shandong (CN)

(72) Inventors: Wei LIU, Jinan, Shandong (CN); Hongliang WANG, Jinan, Shandong (CN); Qi MU, Jinan, Shandong (CN); Shengcai LU, Jinan, Shandong (CN)

(21) Appl. No.: 18/870,426

(22) PCT Filed: Jul. 24, 2023
(86) PCT No.: PCT/CN2023/108941

§ 371 Date: Nov. 28, 2024

(30) Foreign Application Priority Data
Nov. 15, 2022 (CN) 202211422896.3

(51) Int. Cl. G06F 13/16; G06F 9/30; H04L 69/08

(52) U.S. Cl. CPC G06F 13/1668; G06F 9/30098; H04L 69/08

(57) ABSTRACT

Provided is a data migration method, including: setting a read data length and an initial read address of a first bus to a read data length register and a read address register in a preset protocol conversion chip; calculating, by a controller in the preset protocol conversion chip, a burst read address and a burst length of each burst on the first bus based on the initial read address and the read data length, transferring the burst read address and the burst length to a first bus slave chip, causing the first bus slave chip to read data in a memory and return the data to the preset protocol conversion chip; placing, by a packetizer in the preset protocol conversion chip, the data onto a second bus, and providing the data to a FPGA algorithm chip through the second bus.

### CROSS REFERENCE TO RELATED APPLICATIONS

The application claims priority to Chinese Patent Application No. 202211422896.3, filed to the China National Intellectual Property Administration on Nov. 15, 2022 and entitled “DATA MIGRATION METHOD AND APPARATUS, DEVICE, AND MEDIUM”, the entire contents of which are incorporated herein by reference.

### TECHNICAL FIELD

The disclosure relates to the technical field of Field Programmable Gate Array (FPGA) data migration, in particular to a data migration method and a data migration apparatus, a device, and a medium.

### BACKGROUND

With the popularization and application development of technologies such as AI, big data, 5G and deep learning, tasks of internet servers are becoming increasingly severe, the performance of a Central Processing Unit (CPU) is no longer sufficient to support various business demands such as videos and images, and heterogeneous acceleration has become an effective solution. The heterogeneous acceleration usually means that a processor such as an Application Specific Integrated Circuit (ASIC), an FPGA and a Graphics Processing Unit (GPU) is utilized to assist the CPU with computations, alleviating the workload on the CPU, that is, data stored in the memory of the host is moved to the FPGA, the GPU or a dedicated chip for accelerated computation, and the data is moved back to the host after the computation is completed. However, problems of protocol conversion and data flow scheduling between FPGA storage and an acceleration algorithm core often exist in in the design of an Intel FPGA heterogeneous acceleration system.

### SUMMARY

In view of the above, objects of the disclosure are to provide a data migration method and a data migration apparatus, a device, and a medium.

A first aspect of the present disclosure provides a data migration method, including:
setting a read data length and an initial read address of an Avalon-Memory Map (Avalon-MM) bus to a read data length register and a read address register in a preset protocol conversion module respectively;
calculating, by a controller in the preset protocol conversion module, a burst read address and a burst length of each burst on the Avalon-MM bus based on the initial read address and the read data length, transferring the burst read address and the burst length to an Avalon-MM bus slave module, and causing the Avalon-MM bus slave module to read data in a memory and return the data to the preset protocol conversion module; and
placing, by a packetizer in the preset protocol conversion module, the data onto an Avalon-ST bus, and providing the data to a Field Programmable Gate Array (FPGA) algorithm module through the Avalon-ST bus, wherein the FPGA algorithm module is a module built based on FPGA and configured to perform data computation by adopting a preset algorithm.

In some embodiments of the present disclosure, the transferring the burst read address and the burst length to an Avalon-MM bus slave module includes: transferring a burst read address signal carrying the burst read address, a burst length signal carrying the burst length and a read signal to the Avalon-MM bus slave module, so that the Avalon-MM bus slave module reads the data in the memory based on the burst read address and the burst length when the read signal is valid.

In some embodiments of the present disclosure, the data migration method further includes: storing, by the controller in the preset protocol conversion module, the data returned by the Avalon-MM bus slave module into a temporary data module.

In some embodiments of the present disclosure, the data migration method further includes: acquiring a read data signal and a read data valid signal that are returned by the Avalon-MM bus slave module, and storing the data returned by the Avalon-MM bus slave module into the temporary data module when the read data valid signal is valid; wherein the read data signal carries the data read from the memory.

In some embodiments of the present disclosure, the data migration method further includes: in response to a remaining storage capacity of the temporary data module being not sufficient to store data read by one burst, pausing reading data.

In some embodiments of the present disclosure, the data migration method further includes: when the data returned by the Avalon-MM bus slave module reaches the read data length, ending reading data.

In some embodiments of the present disclosure, the placing, by a packetizer in the preset protocol conversion module, the data onto an Avalon-ST bus includes: reading, by the packetizer in the preset protocol conversion module, data from the temporary data module, and placing the data onto the Avalon-ST bus.

In some embodiments of the present disclosure, the data migration method further includes: setting a work trigger register of the preset protocol conversion module, causing the preset protocol conversion module to activate the controller and the packetizer to work; and setting a working status characterization register to be in a working status.

In some embodiments of the present disclosure, the data migration method further includes: setting the working status characterization register to be in an idle status after data transmission is ended.

In some embodiments of the present disclosure, the data migration method further includes: setting an Avalon-ST bus channel number to a channel number register in the preset protocol conversion module; wherein the channel number register is a register for storing the Avalon-ST bus channel number; the placing, by a packetizer in the preset protocol conversion module, the data onto an Avalon-ST bus includes: placing, by the packetizer in the preset protocol conversion module, the data onto a channel corresponding to the Avalon-ST bus channel number of the Avalon-ST bus.

In some embodiments of the present disclosure, the providing the data to a Field Programmable Gate Array (FPGA) algorithm module through the Avalon-ST bus includes: providing the data to the FPGA algorithm module through the channel corresponding to the Avalon-ST bus channel number, and performing a handshake protocol based on valid-ready during data transmission.

In some embodiments of the present disclosure, the performing a handshake protocol based on valid-ready during data transmission includes: sending a startofpacket signal to the FPGA algorithm module through the Avalon-ST bus when the data transmission begins.

In some embodiments of the present disclosure, the data migration method further includes: sending an endofpacket signal to the FPGA algorithm module through the Avalon-ST bus when the data transmission is ended.

In some embodiments of the present disclosure, the data migration method further includes: setting, through an Advanced Peripheral Bus (APB), the initial read address and the read data length of the Avalon-MM bus to the read address register and the read data length register in the preset protocol conversion module respectively, and setting the Avalon-ST bus channel number to the channel number register in the preset protocol conversion module.

In some embodiments of the present disclosure, the setting, through an Advanced Peripheral Bus (APB), the initial read address and the read data length of the Avalon-MM bus to the read address register and the read data length register in the preset protocol conversion module respectively, and setting the Avalon-ST bus channel number to the channel number register in the preset protocol conversion module, includes: utilizing a Central Processing Unit (CPU) to perform the step of setting, through an Advanced Peripheral Bus (APB), the initial read address and the read data length of the Avalon-MM bus to the read address register and the read data length register in the preset protocol conversion module respectively, and setting the Avalon-ST bus channel number to the channel number register in the preset protocol conversion module.

In some embodiments of the present disclosure, the CPU is an internal CPU or external CPU of the FPGA, the external CPU schedules data by means of a pcie Bar space mechanism, and the internal CPU is an Advanced RISC Microprocessor (ARM) hard core embedded into the FPGA or a soft core logically built by the FPGA.

A second aspect of the present disclosure provides a data migration apparatus, including a register setting module and a preset protocol conversion module, the register setting module is configured to set an initial read address and a read data length of an Avalon-MM bus to a read address register and a read data length register in the preset protocol conversion module respectively; the preset protocol conversion module includes a controller and a packetizer; the controller is configured to calculate a burst read address and a burst length of each burst on the Avalon-MM bus based on the initial read address and the read data length, and transfer the burst read address and the burst length to an Avalon-MM bus slave module, cause the Avalon-MM bus slave module to read data in a memory and return the data to the preset protocol conversion module; and the packetizer is configured to place the data onto an Avalon-ST bus and provide the data to an FPGA algorithm module through the Avalon-ST bus.

A third aspect of the present disclosure provides an electronic device, including a storage unit and a processing unit, the storage unit is configured to store a computer program; and the processing unit is configured to execute the computer program to implement the data migration method described above.

A fourth aspect of the present disclosure provides a non-transitory computer-readable storage medium storing a computer program that, when executed by a processor, implements the data migration method described above.

### BRIEF DESCRIPTION OF THE DRAWINGS

In order to describe the technical solutions in the embodiments of the disclosure or the related art more clearly, the accompanying drawings required for describing the embodiments or the related art will be briefly introduced below. Apparently, the accompanying drawings in the following description show only some embodiments of the disclosure, and those skilled in the art can also derive other accompanying drawings from these accompanying drawings without paying creative efforts.

FIG. 1 is a flowchart of a data migration method provided by an embodiment of the disclosure;

FIG. 2 is a schematic diagram illustrating data migration in the related art;

FIG. 3 is a schematic diagram illustrating data migration provided by an embodiment of the disclosure;

FIG. 4 is a schematic diagram of a specific Avalon-MM to Avalon-ST conversion module provided by an embodiment of the disclosure;

FIG. 5 is a schematic structural diagram of a data migration apparatus provided by an embodiment of the disclosure; and

FIG. 6 is a structural principle diagram of an electronic device provided by an embodiment of the disclosure.

### DETAILED DESCRIPTION OF THE EMBODIMENTS

The technical solutions in the embodiments of the disclosure will be described clearly and completely below in conjunction with the accompanying drawings in the embodiments of the disclosure. Apparently, the described embodiments are only a part of the embodiments of the disclosure, not all the embodiments. Based on the embodiments of the disclosure, all other embodiments obtained by those skilled in the art without paying creative effects shall fall within the protective scope of the disclosure.

First, terms involved in the disclosure are explained.
FPGA: Field Programmable Gate Arrays;
IC: Integrated Circuit which is commonly known as a chip;
FIFO: First-In First-Out storage;
DDR: Double Data Rate synchronous dynamic random access memory which is one type of memories;
RAM: Random Access Memory;
AXI bus: Advanced extensible Interface which is a bus protocol, AXI bus is the most important part of an AMBA (Advanced Microcontroller Bus Architecture) 3.0 protocol proposed by ARM corporation;
Pcie: peripheral component interconnect express which is a high-speed serial computer extension bus standard;
ASIC: Application Specific Integrated Circuit;
Avalon bus: the bus is proposed by intel, and is usually used in the design of an Intel FPGA system for high-speed data flow transmission, reading and writing registers, controlling a memory and external devices;
Avalon-Stream, also known as Avalon-ST or AVST, it is the streaming mode of the Avalon bus. AVST is simple in protocols, supports a unidirectional data stream, has no address line, and is generally used in a scenario requiring high bandwidth and low latency;
Avalon-Memory Map, also known as Avalon-MM or AVMM, it has an address line, and is generally used for read and write operations of a status register and a control register; AVMM supports a burst mode, mainly used for transferring mass data in the burst mode; and AVMM is complex in protocol; and
APB: Advanced Peripheral Bus, which is one of AMBA bus structures proposed by the ARM Corporation, and has almost become a standard on-chip bus structure.

At present, in the FPGA, an algorithm module is required to directly control an original Random Access Memory (RAM) interface to read data in the RAM, or the algorithm module is required to directly utilize an Avalon-MM bus to actively read data in DDR chips. However, the existing technology has the following defects that: 1. When acquiring data, the algorithm core needs to directly control the RAM interface or a DDR controller, and these interfaces both have enable signals, read or write selection signals, address signals, data and the like, making protocols relatively complex; the key point is that control and computation are not separated, with very high coupling, which is not conducive to the development, maintenance, and portability of algorithmic modules. 2. The solution is relatively simple, non-standard, with extremely poor generality. It can meet the needs of some small-scale applications and development, but cannot meet the integration at the level of large-scale integrated circuit systems. To this end, the disclosure provides a data migration solution, by which control on reading data can be decoupled from the algorithm module, thus the convenience of the development, maintenance and portability of the algorithm module can be improved, and higher generality is achieved.

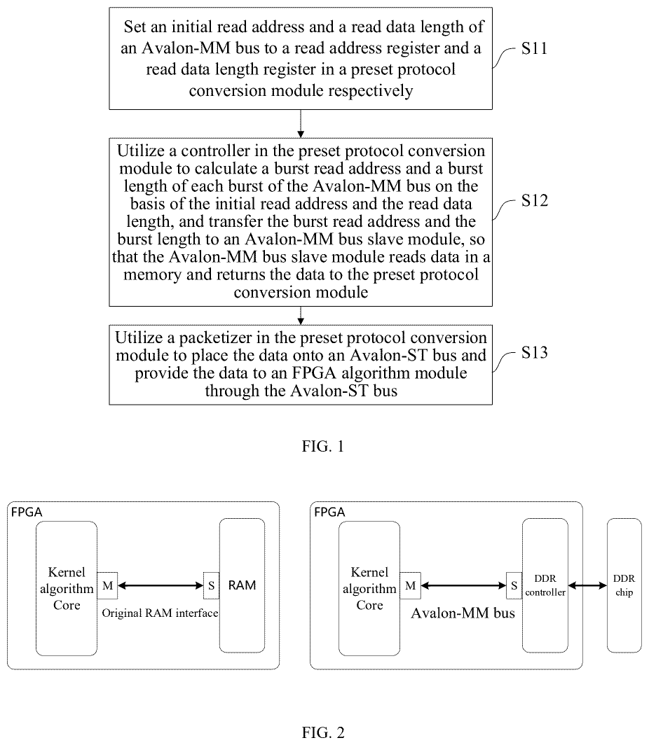

Referring to FIG. 1, an embodiment of the disclosure provides a data migration method including steps S11˜S13.

At step S11, an initial read address and a read data length of an Avalon-MM bus are respectively set to a read address register and a read data length register in a preset protocol conversion module.

At step S12, a controller in the preset protocol conversion module is utilized to calculate a burst read address and a burst length of each burst on the Avalon-MM bus based on the initial read address and the read data length, and transfer the burst read address and the burst length to an Avalon-MM bus slave module, so that the Avalon-MM bus slave module reads data in a memory and returns the data to the preset protocol conversion module.

In a specific implementation, a burst read address signal carrying the burst read address, a burst length signal carrying the burst length and a read signal can be transferred to the Avalon-MM bus slave module, so that the Avalon-MM bus slave module reads the data in the memory based on the burst read address and the burst length when the read signal is valid.

Moreover, in the embodiment of the disclosure, the controller in the preset protocol conversion module can be utilized to store the data returned from the Avalon-MM bus slave module into a temporary data module. The temporary data module may be a First-In First-Out (FIFO) storage device.

Further, in a specific implementation, a read data signal and a read data valid signal that are returned from the Avalon-MM bus slave module can be acquired, and data returned from the Avalon-MM bus slave module can be stored into the temporary data module when the read data valid signal is valid; where the read data signal carries data read from the memory.

Moreover, if the remaining storage capacity of the temporary data module is not sufficient to store data read by one burst, data reading is paused. When the data returned from the Avalon-MM bus slave module reaches the read data length, the data reading is ended.

At step S13, a packetizer in the preset protocol conversion module is utilized to place the data onto an Avalon-ST bus, and the data is provided to an FPGA algorithm module through the Avalon-ST bus.

It can be understood that the FPGA algorithm module is a module achieved based on FPGA that adopts a preset algorithm to preform data computations, and the preset algorithm corresponds to a computational task. For example, if the computational task is an encryption or decryption task, then the preset algorithm is an encryption or decryption algorithm; if the calculation task is an image processing task, then the preset algorithm is an image processing algorithm.

In a specific implementation, the packetizer in the preset protocol conversion module can be utilized to read data from the temporary data module, and the data is placed onto the Avalon-ST bus.

Further, in the embodiment of the disclosure, an Avalon-ST bus channel number can be set to a channel number register in the preset protocol conversion module. Accordingly, the step that the packetizer in the preset protocol conversion module is utilized to place the data onto the Avalon-ST bus includes: the packetizer in the preset protocol conversion module is utilized to place the data onto a channel corresponding to the Avalon-ST bus channel number of the Avalon-ST bus.

Moreover, the data is provided to the FPGA algorithm module through the channel corresponding to the Avalon-ST bus channel number, and a handshake protocol is performed based on valid-ready during data transmission. When the data transmission begins, a startofpacket signal is sent to the FPGA algorithm module through the Avalon-ST bus; and when the data transmission is ended, an endofpacket signal is sent to the FPGA algorithm module through the Avalon-ST bus.

In addition, in the embodiment of the disclosure, a work trigger register of the preset protocol conversion module can be configured, so that the preset protocol conversion module activates the controller and the packetizer to work, and a working status characterization register is set to be in a working status. Moreover, after the data transmission is ended, the working status characterization register is set to be in an idle status.

Moreover, in the embodiment of the disclosure, the initial read address and the read data length of the Avalon-MM bus are respectively set, through an APB, to the read address register and the read data length register in the preset protocol conversion module, the Avalon-ST bus channel number is set to the channel number register in the preset protocol conversion module, and the work trigger register and the working status characterization register of the preset protocol conversion module are set.

Further, a CPU is utilized to set, through the APB, the initial read address and the read data length of the Avalon-MM bus to the read address register and the read data length register in the preset protocol conversion module respectively, set the Avalon-ST bus channel number to the channel number register in the preset protocol conversion module, and configure the work trigger register and the working status characterization register of the preset protocol conversion module.

The CPU may be an internal CPU inside the FPGA or an external CPU. The external CPU schedules data by means of a pcie Bar space mechanism. The internal CPU may be an ARM hard core embedded into the FPGA or a soft core logically built by the FPGA. That is, the Avalon-MM protocol is converting into the Avalon-ST protocol through the embodiment of the disclosure. The internal CPU or external CPU of the FPGA is utilized to schedule the data, so that the data in the RAM or DDR is actively sent to the algorithm module, rather than letting the reading controlled by the algorithm module.

The Avalon-MM bus slave module, i.e., a slave module corresponding to the preset protocol conversion module, is a preset Avalon-MM bus interconnection module. The preset Avalon-MM bus interconnection module reads data in the DDR or RAM by means of a DDR controller or an RAM controller. With respect to the preset Avalon-MM bus interconnection module, the DDR controller or the RAM controller is a slave module.

It can be seen that, in the embodiment of the disclosure, the initial read address and the read data length of the Avalon-MM bus are respectively set to the read address register and the read data length register in the preset protocol conversion module; the controller in the preset protocol conversion module is utilized to calculate the burst read address and the burst length of each burst on the Avalon-MM bus based on the initial read address and the read data length, and the burst read address and the burst length are transferred to the Avalon-MM bus slave module; the Avalon-MM bus slave module reads data in the memory and returns the data to the preset protocol conversion module; and the packetizer in the preset protocol conversion module is utilized to place the data onto the Avalon-ST bus, and the data is provided to the FPGA algorithm module through the Avalon-ST bus. That is, in the disclosure, the registers in the preset protocol conversion module are set, the controller in the preset protocol conversion module is utilized to calculate the burst read address and the burst length of each burst on the Avalon-MM bus based on the initial read address and the read data length in the registers, and the burst read address and the burst length are transferred to the Avalon-MM bus slave module, so that the Avalon-MM bus slave module reads the data in the memory and returns the data to the preset protocol conversion module; and the packetizer in the preset protocol conversion module is utilized to place the data onto the Avalon-ST bus, and the data is provided to the FPGA algorithm module through the Avalon-ST bus. In this way, the Avalon-MM bus protocol is converted into the Avalon-ST bus protocol, and the data is actively provided to the algorithm module, rather than letting the reading controlled by the algorithm module itself. Therefore, control on reading data can be decoupled from the algorithm module, the convenience of the development, maintenance and portability of the algorithm module can be improved. Moreover. Since being designed based on a standard bus protocol, design and integration on a system level are facilitated, and higher generality is achieved.

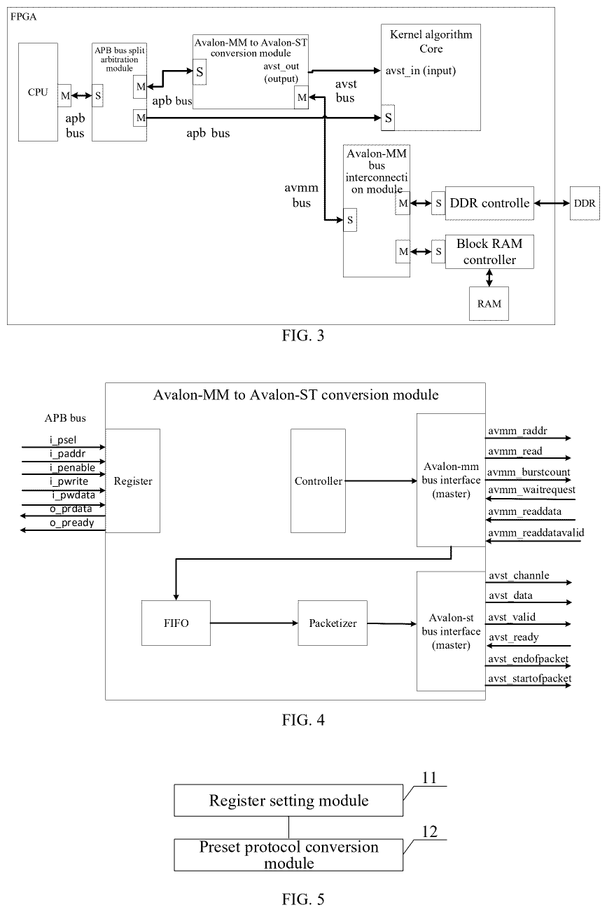

Further, referring to FIG. 2, FIG. 2 is a schematic diagram illustrating data migration in the related art. At present, in the FPGA, an algorithm module is required to directly control an original RAM interface to read data in the RAM, or the algorithm module directly utilizes an Avalon-MM bus to actively read data in DDR chips. Referring to FIG. 3, FIG. 3 is a schematic diagram illustrating data migration provided in the present disclosure. An internal CPU of the FPGA is utilized to schedule data, and data in the RAM or DDR is actively provided to the algorithm module, rather than controlling data reading by the algorithm module itself. The system mainly consists of modules such as a CPU, an APB split arbitration module, an Avalon-MM to Avalon-ST conversion module (i.e., the aforesaid preset protocol conversion module), a kernel (an algorithm core, i.e., the aforesaid FPGA algorithm module), an Avalon-MM bus interconnection module, a DDR controller, a Block RAM (i.e., block random access memory) controller. The CPU can be an ARM hard core embedded into the FPGA or a soft core logically built by the FPGA, and mainly responsible for control. The Avalon-MM bus interconnection module is used for bus split arbitration, where S represents a bus slave (slave), and M represents a bus master (master). The DDR controller and the Block RAM controller respectively control an external memory DDR and an internal memory RAM. The kernel is an algorithm core and responsible for acceleration algorithm. The Avalon-MM to Avalon-ST conversion module is responsible for converting an Avalon-MM bus into an Avalon-ST bus, and transferring data in the DDR or RAM to the kernel. The APB bus has a relatively low rate bandwidth, and is used for read or write configuration of registers. Referring to FIG. 4, FIG. 4 is a schematic diagram of a specific Avalon-MM to Avalon-ST conversion module provided by an embodiment of the disclosure. The Avalon-MM to Avalon-ST conversion module includes modules such as a register, an FIFO, a packetizer, an APB bus, an Avalon-MM bus interface, an Avalon-ST bus interface. The register is configured through the APB bus.

A register list is shown in table 1, where R/W represents readable and writable, WT represents write trigger, and RO represents read only.

TABLE 1

| Address | | Access | |
|---|---|---|---|
| offset | Register | right | Description |
| 0x00 | write_addr | R/W | Avalon-MM initial write address |
| 0x04 | write_length | R/W | Avalon-MM write data length |
| 0x08 | channel | R/W | Avalon-ST channel number |
| 0x0C | Start | WT | signal indicating that Module starts |
| | | | to work |
| 0x10 | Status | RO | 0 represents that the module is idle, and |
| | | | 1 represents that the module is busy. |

The controller calculates the burst read address (avmm_raddr) and the burst length (avmm_burstcount) of each burst on the Avalon-MM bus based on the initial read address and the read data length of the Avalon-MM. After register ‘start’ is triggered, the controller transfers the burst address and the burst length to the slave module through an avmm_read signal (i.e., the aforesaid read signal), and the slave module returns the data in the RAM or the DDR through an avmm_readdata signal (i.e., the aforesaid read data signal) and an avmm_readdatavalid signal (i.e., the aforesaid read data valid signal). When the Avmm_waitrequest signal is high, it represents that the slave module is busy, handshake is invalid. The temporary data module is an FIFO and is configured to temporarily store the data returned by the Avalon-MM BUS. The packetizer fetches the data out of the FIFO and places the data onto the Avalon-ST bus, when data transmission begins, an avst_startofpacket signal is enabled, and when the data transmission is ended, an avst_endofpacket signal is enabled, where avst_channle represents a serial number of a channel and is configured according to the register ‘channel’. The avst_valid and avst_ready are transmission handshake signals, and avst_data represents data. i_psel, i_paddr, i_penable, i_pwrite, i_pwdata, o_prdata and o_pready are all signals designed based on an APB protocol, and are used for setting the register.

Further, operation steps of the Avalon-MM to Avalon-ST conversion module are described as follows: 1. setting three registers ‘Read_addr’, ‘Read_length’ and ‘channel’ through the APB bus, so as to inform the module an address of the Avalon-MM bus where data fetching begins, a amount of data to be fetched and a channel of the Avalon-ST where the data is to be placed. 2. writing register ‘start’ through the APB bus, so as to inform the module to start to work, and setting register ‘Status’ as high after the module works. 3. controlling the Avalon-MM bus by the controller to read data in the RAM or the DDR, and place the read data into the FIFO; when the amount of the read data is equal to Read_length, stopping fetching data; if the FIFO is not sufficient to store the amount of data in one burst during data reading, it is necessary to pause fetching data, and when the remaining storage capacity of the FIFO is greater than the amount of data fetched in the one burst of the Avalon-MM bus, resuming fetching data. 4. After receiving start, the packetizer waits for the data in the FIFO, after there is data, the startofpacket signal and data are enabled, and when the data transmission is ended (the amount of data sent is equal to Read_legth), the endofpacket signal is enabled, where avst_channle represents a serial number of a channel, and is set according to register ‘channel’. 5. After the transmission of the packetizer is ended, the register ‘status’ is set as low, which represents that the module is idle.

It can be seen that, in the embodiment of the disclosure, all modules are designed using standard bus protocols, which greatly facilitates system-level design and integration. The decoupling between modules ensures the maximum independence, portability, and maintainability of each module. Converting the Avalon-MM bus protocol to the Avalon-ST bus protocol simplifies the interface control of the kernel algorithm calculation module, allowing the algorithm module to focus on computation rather than control. The scheduling method of this embodiment can achieve full pipelining, with all modules operating synchronously. By setting addresses, lengths, and channels through registers, the system's flexibility is enhanced, and control authority is delivered to CPU as possible, greatly facilitating the development and design of CPU control programs. Moreover, since digital ICs and FPGAs are both digital circuit designs, the solution provided by this application is applicable to both FPGA design and digital IC design.

Referring to FIG. 5, an embodiment of the disclosure provides a data migration apparatus, including a register setting module 11 and a preset protocol conversion module 12.

The register setting module 11 is configured to set a read data length and an initial read address of an Avalon-MM bus to a read data length register and a read address register in the preset protocol conversion module 12 respectively.

The preset protocol conversion module 12 includes a controller and a packetizer.

The controller is configured to calculate a burst read address and a burst length of each burst on the Avalon-MM bus based on the initial read address and the read data length, and transfer the burst read address and the burst length to an Avalon-MM bus slave module, so that the Avalon-MM bus slave module reads data in a memory and returns the data to the preset protocol conversion module 12.

The packetizer is configured to place the data onto an Avalon-ST bus, and provide the data to an FPGA algorithm module through the Avalon-ST bus.

It can be seen that, in the embodiment of the disclosure, the read data length and the initial read address of the Avalon-MM bus are respectively set to the read data length register and the read address register in the preset protocol conversion module; the controller in the preset protocol conversion module is utilized to calculate the burst read address and the burst length of each burst on the Avalon-MM bus based on the initial read address and the read data length, and the burst read address and the burst length are transferred to the Avalon-MM bus slave module, so that the Avalon-MM bus slave module reads the data in the memory and returns the data to the preset protocol conversion module; and the packetizer in the preset protocol conversion module is utilized to place the data onto the Avalon-ST bus, and the data is provided to the FPGA algorithm module through the Avalon-ST bus. That is, in the embodiment of the disclosure, registers in the preset protocol conversion module are set; the controller in the preset protocol conversion module is utilized to calculate the burst read address and burst length for each burst on the Avalon-MM bus based on the initial read address and read data length in the registers, and the burst read address and burst length are transferred to the Avalon-MM bus slave module, so that the Avalon-MM bus slave module may read data from the memory and return the data to the preset protocol conversion module; the packetizer in the preset protocol conversion module is utilized to place the data onto the Avalon-ST bus, and the data is provided to the FPGA algorithm module through the Avalon-ST bus. In this way, the Avalon-MM bus protocol is converted to the Avalon-ST bus protocol, and data is actively provided to the algorithm module instead of having the algorithm module itself control the reading. Therefore, the control on data reading can be decoupled from the algorithm module, enhancing the convenience of developing, maintaining, and porting the algorithm module. Moreover, the design based on standard bus protocols facilitates system-level design and integration, offering good generality.

Further, the controller is configured to transfer a burst read address signal carrying the burst read address, a burst length signal carrying the burst length and a read signal to the Avalon-MM bus slave module, so that the Avalon-MM bus slave module reads the data in the memory based on the burst read address and the burst length when the read signal is valid.

Moreover, the controller is further configured to store the data returned by the Avalon-MM bus slave module into a temporary data module.

The preset protocol conversion module 12 is further configured to acquire a read data signal and a read data valid signal for data returned by the Avalon-MM bus slave module, and the data returned by the Avalon-MM bus slave module is stored into the temporary data module by the controller when the read data valid signal is valid; where the read data signal carries data read from the memory.

The controller is further configured to, in response to the remaining storage capacity of the temporary data module is not sufficient to store data read by one burst, pause reading data; and in response to the data returned by the Avalon-MM bus slave module reaching the read data length, end reading data.

Further, the packetizer is configured to read data from the temporary data module, and place the data onto the Avalon-ST bus.

Further, the register setting module 11 is further used for setting a work trigger register of the preset protocol conversion module, so that the preset protocol conversion module activates the controller and the packetizer to work. Moreover, the register setting module 11 is further used for setting a working status characterization register to be in a working status.

Further, the register setting module 11 is further used for setting an Avalon-ST bus channel number to a channel number register in the preset protocol conversion module.

Accordingly, the packetizer is configured to place the data onto a channel corresponding to the Avalon-ST bus channel number of the Avalon-ST bus, provide the data to the FPGA algorithm module through the channel corresponding to the Avalon-ST bus channel number, and perform a handshake protocol based on valid-ready during data transmission.

Further, the register setting module 11 is used for, through an APB bus, setting the read data length and the initial read address of the Avalon-MM bus to the read data length register and the read address register in the preset protocol conversion module respectively, and setting the Avalon-ST bus channel number to the channel number register in the preset protocol conversion module.

Further, the register setting module 11 is a CPU. The apparatus utilizes the CPU to set, through the APB bus, the read data length and the initial read address of the Avalon-MM bus to the read data length register and the read address register in the preset protocol conversion module respectively, and set the Avalon-ST bus channel number to the channel number register in the preset protocol conversion module.

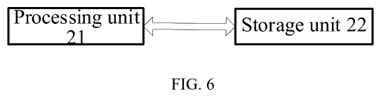

Referring to FIG. 6, an embodiment of the disclosure provides an electronic device, including a processing unit 21 and a storage unit 22. The storage unit 22 is configured to store a computer program. The processing unit 22 is configured to execute the computer program to implement the following steps:
setting a read data length and an initial read address of an Avalon-MM bus to a read data length register and a read address register in a preset protocol conversion module respectively; utilizing a controller in the preset protocol conversion module to calculate a burst read address and a burst length of each burst on the Avalon-MM bus based on the initial read address and the read data length, and transferring the burst read address and the burst length to an Avalon-MM bus slave module, so that the Avalon-MM bus slave module reads data in a memory and returns the data to the preset protocol conversion module; and utilizing a packetizer in the preset protocol conversion module to place the data onto an Avalon-ST bus and providing the data to an FPGA algorithm module through the Avalon-ST bus.

It can be seen that, in the embodiment of the disclosure, the initial read address and the read data length of the Avalon-MM bus are respectively set to the read address register and the read data length register in the preset protocol conversion module; the controller in the preset protocol conversion module is utilized to calculate the burst read address and the burst length of each burst on the Avalon-MM bus based on the initial read address and the read data length, and transfer the burst read address and the burst length to the Avalon-MM bus slave module, so that the Avalon-MM bus slave module reads the data in the memory and returns the data to the preset protocol conversion module; and the packetizer in the preset protocol conversion module is utilized to place the data onto the Avalon-ST bus, and provide the data to the FPGA algorithm module through the Avalon-ST bus. That is, in the embodiment of the disclosure, the registers in the preset protocol conversion module are set, the controller in the preset protocol conversion module is utilized to calculate the burst read address and the burst length of each burst on the Avalon-MM bus based on the initial read address and the read data length in the registers, and the burst read address and the burst length are transferred to the Avalon-MM bus slave module, so that the Avalon-MM bus slave module reads the data in the memory and returns the data to the preset protocol conversion module; and the packetizer in the preset protocol conversion module is utilized to place the data onto the Avalon-ST bus and provide the data to the FPGA algorithm module through the Avalon-ST bus. In this way, an Avalon-MM bus protocol is converted into an Avalon-ST bus protocol, and the data is actively provided to the algorithm module, rather than having the algorithm module itself control the reading. Therefore, control on reading data can be decoupled from the algorithm module, the convenience of the development, maintenance and transfer of the algorithm module can be improved, and based on a standard bus protocol design, design and integration on a system level are facilitated, and higher generality is achieved.

In the present embodiment, when the processing unit 21 executes a computer subprogram stored in the storage unit 22, the following steps can be implemented: a burst read address signal carrying the burst read address, a burst length signal carrying the burst length and a read signal are transferred to the Avalon-MM bus slave module, so that the Avalon-MM bus slave module reads the data in the memory based on the burst read address and the burst length when the read signal is valid.

In the present embodiment, when the processing unit 21 executes a computer subprogram stored in the storage unit 22, the following steps can be implemented: the data returned by the Avalon-MM bus slave module is stored into a temporary data module by the controller in the preset protocol conversion module.

In the present embodiment, when the processing unit 21 executes a computer subprogram stored in the storage unit 22, the following steps can be implemented: a read data signal and a read data valid signal returned by the Avalon-MM bus slave module are acquired, and the data returned by the Avalon-MM bus slave module is stored into the temporary data module when the read data valid signal is valid; where the read data signal carries data read from the memory.

In the present embodiment, when the processing unit 21 executes a computer subprogram stored in the storage unit 22, the following steps can be implemented: if the remaining storage capacity of the temporary data module is not sufficient to store data read by one burst, reading data is paused.

In the present embodiment, when the processing unit 21 executes a computer subprogram stored in the storage unit 22, the following steps can be implemented: when the data returned by the Avalon-MM bus slave module reaches the read data length, reading data is ended.

In the present embodiment, when the processing unit 21 executes a computer subprogram stored in the storage unit 22, the following steps can be implemented: the packetizer in the preset protocol conversion module is utilized to read data from the temporary data module, and the data is placed onto the Avalon-ST bus.

In the present embodiment, when the processing unit 21 executes a computer subprogram stored in the storage unit 22, the following steps can be implemented: a work trigger register of the preset protocol conversion module is configured, so that the preset protocol conversion module activates the controller and the packetizer to work; and a working status characterization register is set to be in a working status.

In the present embodiment, when the processing unit 21 executes a computer subprogram stored in the storage unit 22, the following steps can be implemented: an Avalon-ST bus channel number is set to a channel number register in the preset protocol conversion module.

In the present embodiment, when the processing unit 21 executes a computer subprogram stored in the storage unit 22, the following steps can be implemented: the packetizer in the preset protocol conversion module is utilized to place the data onto a channel corresponding to the Avalon-ST bus channel number of the Avalon-ST bus.

In the present embodiment, when the processing unit 21 executes a computer subprogram stored in the storage unit 22, the following steps can be implemented: the data is provided to the FPGA algorithm module through the channel corresponding to the Avalon-ST bus channel number, and a handshake protocol is performed based on valid-ready during data transmission.

In the present embodiment, when the processing unit 21 executes a computer subprogram stored in the storage unit 22, the following steps can be implemented: the read data length and the initial read address of the Avalon-MM bus are respectively set to the read data length register and the read address register in the preset protocol conversion module through an APB bus, and the Avalon-ST bus channel number is set to the channel number register in the preset protocol conversion module.

In the present embodiment, when the processing unit 21 executes a computer subprogram stored in the storage unit 22, the following steps can be implemented: a CPU is utilized to configure, through the APB bus, the read data length and the initial read address of the Avalon-MM bus to the read data length register and the read address register in the preset protocol conversion module respectively, and configure the Avalon-ST bus channel number to the channel number register in the preset protocol conversion module.

Further, an embodiment of the disclosure discloses a non-transitory computer-readable storage medium storing a computer program that, when executed by a processor, implements the following steps.

It can be seen that, in the embodiment of the disclosure, the initial read address and the read data length of the Avalon-MM bus are respectively set to the read address register and the read data length register in the preset protocol conversion module; the controller in the preset protocol conversion module is utilized to calculate the burst read address and the burst length of each burst on the Avalon-MM bus based on the initial read address and the read data length, and transfer the burst read address and the burst length to the Avalon-MM bus slave module, so that the Avalon-MM bus slave module reads the data in the memory and returns the data to the preset protocol conversion module; and the packetizer in the preset protocol conversion module is utilized to place the data onto the Avalon-ST bus, and provide the data to the FPGA algorithm module through the Avalon-ST bus. That is, in the embodiment of the disclosure, the registers in the preset protocol conversion module are set, the controller in the preset protocol conversion module is utilized to calculate the burst read address and the burst length of each burst on the Avalon-MM bus based on the initial read address and the read data length in the registers, and the burst read address and the burst length are transferred to the Avalon-MM bus slave module, so that the Avalon-MM bus slave module reads the data in the memory and returns the data to the preset protocol conversion module; and the packetizer in the preset protocol conversion module is utilized to place the data onto the Avalon-ST bus and provide the data to the FPGA algorithm module through the Avalon-ST bus. In this way, an Avalon-MM bus protocol is converted into an Avalon-ST bus protocol, and the data is actively provided to the algorithm module, rather than having the algorithm module itself control the reading. Therefore, control on reading data can be decoupled from the algorithm module, the convenience of the development, maintenance and transfer of the algorithm module can be improved, and based on a standard bus protocol design, design and integration on a system level are facilitated, and higher generality is achieved.

The read data length and the initial read address of an Avalon-MM bus are respectively set to the read data length register and the read address register in the preset protocol conversion module. The controller in the preset protocol conversion module is utilized to calculate the burst read address and the burst length of each burst on the Avalon-MM bus based on the initial read address and the read data length, and the burst read address and the burst length are transferred to the Avalon-MM bus slave module, so that the Avalon-MM bus slave module reads data in the memory and returns the data to the preset protocol conversion module. The packetizer in the preset protocol conversion module is utilized to place the data onto an Avalon-ST bus, and provide the data to the FPGA algorithm module through the Avalon-ST bus.

It can be seen that, in the embodiment of the disclosure, the initial read address and the read data length of the Avalon-MM bus are respectively set to the read address register and the read data length register in the preset protocol conversion module; the controller in the preset protocol conversion module is utilized to calculate the burst read address and the burst length of each burst on the Avalon-MM bus based on the initial read address and the read data length, and transfer the burst read address and the burst length to the Avalon-MM bus slave module, so that the Avalon-MM bus slave module reads the data in the memory and returns the data to the preset protocol conversion module; and the packetizer in the preset protocol conversion module is utilized to place the data onto the Avalon-ST bus, and provide the data to the FPGA algorithm module through the Avalon-ST bus. That is, in the embodiment of the disclosure, the registers in the preset protocol conversion module are set, the controller in the preset protocol conversion module is utilized to calculate the burst read address and the burst length of each burst on the Avalon-MM bus based on the initial read address and the read data length in the registers, and the burst read address and the burst length are transferred to the Avalon-MM bus slave module, so that the Avalon-MM bus slave module reads the data in the memory and returns the data to the preset protocol conversion module; and the packetizer in the preset protocol conversion module is utilized to place the data onto the Avalon-ST bus and provide the data to the FPGA algorithm module through the Avalon-ST bus. In this way, an Avalon-MM bus protocol is converted into an Avalon-ST bus protocol, and the data is actively provided to the algorithm module, rather than having the algorithm module itself control the reading. Therefore, control on reading data can be decoupled from the algorithm module, the convenience of the development, maintenance and transfer of the algorithm module can be improved, and based on a standard bus protocol design, design and integration on a system level are facilitated, and higher generality is achieved.

In the present embodiment, when the computer subprogram stored in the non-transitory computer-readable storage medium is executed by the processor, the following steps can be implemented: a burst read address signal carrying the burst read address, a burst length signal carrying the burst length and a read signal are transferred to the Avalon-MM bus slave module, so that the Avalon-MM bus slave module reads the data in the memory based on the burst read address and the burst length when the read signal is valid.

In the present embodiment, when the computer subprogram stored in the non-transitory computer-readable storage medium is executed by the processor, the following step can be implemented: the controller in the preset protocol conversion module is utilized to store the data returned by the Avalon-MM bus slave module into a temporary data module.

In the present embodiment, when the computer subprogram stored in the non-transitory computer-readable storage medium is executed by the processor, the following step can be implemented: a read data signal and a read data valid signal that are returned by the Avalon-MM bus slave module are acquired, and the data returned by the Avalon-MM bus slave module is stored into the temporary data module when the read data valid signal is valid; where the read data signal carries data read from the memory.

In the present embodiment, when the computer subprogram stored in the non-transitory computer-readable storage medium is executed by the processor, the following step can be implemented: if the remaining storage capacity of the temporary data module is not sufficient to store data read by one burst, reading data is paused.

In the present embodiment, when the computer subprogram stored in the non-transitory computer-readable storage medium is executed by the processor, the following step can be implemented: when the data returned by the Avalon-MM bus slave module reaches the read data length, reading data is ended.

In the present embodiment, when the computer subprogram stored in the non-transitory computer-readable storage medium is executed by the processor, the following step can be implemented: the packetizer in the preset protocol conversion module is utilized to read data from the temporary data module and place the data onto the Avalon-ST bus.

In the present embodiment, when the computer subprogram stored in the non-transitory computer-readable storage medium is executed by the processor, the following step can be implemented: a work trigger register of the preset protocol conversion module is configured, so that the preset protocol conversion module activates the controller and the packetizer to work; and a working status characterization register is set to be in a working status.

In the present embodiment, when the computer subprogram stored in the non-transitory computer-readable storage medium is executed by the processor, the following step can be implemented: an Avalon-ST bus channel number is set to a channel number register in the preset protocol conversion module.

In the present embodiment, when the computer subprogram stored in the non-transitory computer-readable storage medium is executed by the processor, the following step can be implemented: the packetizer in the preset protocol conversion module is utilized to place the data onto a channel corresponding to the Avalon-ST bus channel number of the Avalon-ST bus.

In the present embodiment, when the computer subprogram stored in the non-transitory computer-readable storage medium is executed by the processor, the following step can be implemented: the data is provided to the FPGA algorithm module through the channel corresponding to the Avalon-ST bus channel number, and a handshake protocol is performed based on valid-ready during data transmission.

In the present embodiment, when the computer subprogram stored in the non-transitory computer-readable storage medium is executed by the processor, the following step can be implemented: the read data length and the initial read address of the Avalon-MM bus are set, through the APB bus, to the read data length register and the read address register in the preset protocol conversion module respectively, and the Avalon-ST bus channel number is set to the channel number register in the preset protocol conversion module.

In the present embodiment, when the computer subprogram stored in the non-transitory computer-readable storage medium is executed by the processor, the following step can be implemented: a CPU is utilized to set, through the APB bus, the read data length and the initial read address of the Avalon-MM bus to the read data length register and the read address register in the preset protocol conversion module respectively, and set the Avalon-ST bus channel number to the channel number register in the preset protocol conversion module.

Various embodiments are described in a progressive way, with each focusing on the differences from other embodiments. For similar or identical parts between embodiments, cross-referencing is sufficient. Regarding the apparatus disclosed in the embodiments, since it corresponds to the methods disclosed in the embodiments, the description is relatively simple; for related details, refer to the method section.

The steps of the methods or algorithms described in conjunction with the embodiments disclosed in this document can be implemented directly by hardware, software modules executed by a processor, or a combination of both. Software modules can be stored in random-access memory (RAM), memory, read-only memory (ROM), electrically programmable ROM, electrically erasable programmable ROM, registers, hard disks, removable disks, CDs, DVDs, or any other form of storage medium known in the field.

The above provides a detailed introduction to a data migration method, a data migration apparatus, a device, and a medium provided by the present application. Specific examples are used to illustrate the principles and implementation methods of the present application. The descriptions of the embodiments are only for the purpose of helping to understand the methods and core ideas of the present application. Those skilled in the art may change in the specific implementation methods and scope of application based on the ideas of the present application. In summary, the content of this specification should not be understood as limiting the present application.

1. A data migration method, comprising:
setting a read data length and an initial read address of a first bus to a read data length register and a read address register in a preset protocol conversion chip respectively;
calculating, by a controller in the preset protocol conversion chip, a burst read address and a burst length of each burst on the first bus based on the initial read address and the read data length, transferring the burst read address and the burst length to first bus slave chip, and causing the first bus slave chip to read data in a memory and return the data to the preset protocol conversion chip; and
placing, by a packetizer in the preset protocol conversion chip, the data onto a second bus, and providing the data to a Field Programmable Gate Array (FPGA) algorithm chip through the second bus, wherein the FPGA algorithm chip is a chip built based on FPGA and configured to perform data computation by adopting a preset algorithm.

2. The data migration method according to claim 1, wherein the transferring the burst read address and the burst length to a first bus slave chip comprises:
transferring a burst read address signal carrying the burst read address, a burst length signal carrying the burst length and a read signal to the first bus slave chip, so that the first bus slave chip reads the data in the memory based on the burst read address and the burst length when the read signal is valid.

3. The data migration method according to claim 1, further comprising:
storing, by the controller in the preset protocol conversion chip, the data returned by the first bus slave chip into a temporary data chip.

4. The data migration method according to claim 3, further comprising:
acquiring a read data signal and a read data valid signal that are returned by the Avalon-first bus slave chip, and storing the data returned by the first bus slave chip into the temporary data chip when the read data valid signal is valid; wherein the read data signal carries the data read from the memory.

5. The data migration method according to claim 3, wherein the temporary data chip is a first-in first-out storage device.

6. The data migration method according to claim 3, further comprising:
in response to a remaining storage capacity of the temporary data chip being not sufficient to store data read by one burst, pausing reading data.

7. The data migration method according to claim 3, further comprising:
when the data returned by the first bus slave chip reaches the read data length, ending reading data.

8. The data migration method according to claim 3, wherein the placing, by a packetizer in the preset protocol conversion chip, the data onto an second bus comprises:
reading, by the packetizer in the preset protocol conversion chip, data from the temporary data device, and placing the data onto the second bus.

9. The data migration method according to claim 1, further comprising:
setting a work trigger register of the preset protocol conversion chip, causing the preset protocol conversion chip to activate the controller and the packetizer to work; and
setting a working status characterization register to be in a working status.

10. The data migration method according to claim 9, further comprising:
setting the working status characterization register to be in an idle status after data transmission is ended.

11. The data migration method according to claim 1, further comprising:
setting a second bus channel number to a channel number register in the preset protocol conversion chip; wherein the channel number register is a register for storing the Second bus channel number;
the placing, by a packetizer in the preset protocol conversion chip, the data onto an second bus comprises:
placing, by the packetizer in the preset protocol conversion chip, the data onto a channel corresponding to the second bus channel number of the second bus.

12. The data migration method according to claim 11, wherein the providing the data to a Field Programmable Gate Array (FPGA) algorithm chip through the second bus comprises:
providing the data to the FPGA algorithm chip through the channel corresponding to the second bus channel number, and performing a handshake protocol based on valid-ready during data transmission.

13. The data migration method according to claim 12, wherein the performing a handshake protocol based on valid-ready during data transmission comprises:
sending a startofpacket signal to the FPGA algorithm chip through the second bus when the data transmission begins.

14. The data migration method according to claim 13, further comprising:
sending an endofpacket signal to the FPGA algorithm chip through the second bus when the data transmission is ended.

15. The data migration method according to claim 11, comprising:
setting, through an Advanced Peripheral Bus (APB), the initial read address and the read data length of the first bus to the read address register and the read data length register in the preset protocol conversion chip respectively, and setting the second bus channel number to the channel number register in the preset protocol conversion chip.

16. The data migration method according to claim 15, wherein the setting, through an Advanced Peripheral Bus (APB), the initial read address and the read data length of the first bus to the read address register and the read data length register in the preset protocol conversion chip respectively, and setting the second bus channel number to the channel number register in the preset protocol conversion chip, comprises:
utilizing a Central Processing Unit (CPU) to perform the step of setting, through an Advanced Peripheral Bus (APB), the initial read address and the read data length of the first bus to the read address register and the read data length register in the preset protocol conversion chip respectively, and setting the second bus channel number to the channel number register in the preset protocol conversion chip.

17. The data migration method according to claim 16, wherein the CPU is an internal CPU or external CPU of the FPGA, the external CPU schedules data by means of a pcie Bar space mechanism, and the internal CPU is an Advanced RISC Microprocessor (ARM) hard core embedded into the FPGA or a soft core logically built by the FPGA.

18. (canceled)

19. An electronic device, comprising a storage unit and a processing unit, wherein:
the storage unit is configured to store a computer program; and
the processing unit is configured to execute the computer program to implement the data migration method according to claim 1.

20. A non-transitory computer-readable storage medium storing a computer program, wherein the computer program, when executed by a processor, implements the data migration method according to claim 1.

21. The data migration method according to 1, wherein the first bus is an Avalon-Memory Map (Avalon-MM) bus, and the second bus is an Avalon-Stream (Avalon-ST) bus.
